(19) United States
(12) Patent Application Publication
(10) Pub. No.: US 2025/0392367 A1
(43) Pub. Date: Dec. 25, 2025

(54) FREQUENCY DOMAIN COMPRESSION OF CHANNEL STATE INFORMATION

(71) Applicant: QUALCOMM Incorporated, San Diego, CA (US)

(72) Inventors: Pavan Kumar VITTHALADEVUNI, San Diego, CA (US); Taesang YOO, San Diego, CA (US); Runxin WANG, San Diego, CA (US); June NAMGOONG, San Diego, CA (US); Kirty Prabhakar VEDULA, San Diego, CA (US); Chenxi HAO, Beijing (CN); Yu ZHANG, San Diego, CA (US); Naga BHUSHAN, San Diego, CA (US)

(21) Appl. No.: 18/879,957

(22) PCT Filed: Aug. 11, 2022
(86) PCT No.: PCT/CN2022/111783

§ 371 Date: Dec. 30, 2024

(51) Int. Cl. H04B 7/06

(52) U.S. Cl. CPC H04B 7/0658; H04B 7/0626

(57) ABSTRACT

Various aspects of the present disclosure generally relate to wireless communication. In some aspects, a user equipment (UE) may identify channel information based at least in part on a set of channel state information reference signals (CSI-RSs). The UE may generate compressed channel state information (CSI) using a model, wherein an input of the neural network model is based at least in part on the channel information, and wherein the compressed CSI is compressed in a frequency domain. The UE may transmit the compressed CSI. Numerous other aspects are described.

### FIELD OF THE DISCLOSURE

Aspects of the present disclosure generally relate to wireless communication and to techniques and apparatuses for frequency domain compression of channel state information (CSI).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include identifying channel information based at least in part on a set of CSI-RSs. The method may include generating compressed CSI using a model, wherein an input of the neural network model is based at least in part on the channel information, and wherein the compressed CSI is compressed in a frequency domain. The method may include transmitting the compressed CSI.

Some aspects described herein relate to a method of wireless communication performed by a network node. The method may include receiving compressed CSI that is compressed in a frequency domain. The method may include decompressing the compressed CSI using a model to obtain channel information. The method may include configuring a communication based at least in part on the channel information.

Some aspects described herein relate to a UE for wireless communication. The UE may include a memory and one or more processors coupled to the memory. The one or more processors may be configured to identify channel information based at least in part on a set of CSI-RSs. The one or more processors may be configured to generate compressed CSI using a model, wherein an input of the neural network model is based at least in part on the channel information, and wherein the compressed CSI is compressed in a frequency domain. The one or more processors may be configured to transmit the compressed CSI.

Some aspects described herein relate to a network node for wireless communication. The network node may include a memory and one or more processors coupled to the memory. The one or more processors may be configured to receive compressed CSI that is compressed in a frequency domain. The one or more processors may be configured to decompress the compressed CSI using a model to obtain channel information. The one or more processors may be configured to configure a communication based at least in part on the channel information.

Some aspects described herein relate to a non-transitory computer-readable medium that stores a set of instructions for wireless communication by a UE. The set of instructions, when executed by one or more processors of the UE, may cause the UE to identify channel information based at least in part on a set of CSI-RSs. The set of instructions, when executed by one or more processors of the UE, may cause the UE to generate compressed CSI using a model, wherein an input of the neural network model is based at least in part on the channel information, and wherein the compressed CSI is compressed in a frequency domain. The set of instructions, when executed by one or more processors of the UE, may cause the UE to transmit the compressed CSI.

Some aspects described herein relate to a non-transitory computer-readable medium that stores a set of instructions for wireless communication by a network node. The set of instructions, when executed by one or more processors of the network node, may cause the network node to receive compressed CSI that is compressed in a frequency domain. The set of instructions, when executed by one or more processors of the network node, may cause the network node to decompress the compressed CSI using a model to obtain channel information. The set of instructions, when executed by one or more processors of the network node, may cause the network node to configure a communication based at least in part on the channel information.

Some aspects described herein relate to an apparatus for wireless communication. The apparatus may include means for identifying channel information based at least in part on a set of CSI-RSs. The apparatus may include means for generating compressed CSI using a model, wherein an input of the neural network model is based at least in part on the channel information, and wherein the compressed CSI is compressed in a frequency domain. The apparatus may include means for transmitting the compressed CSI.

Some aspects described herein relate to an apparatus for wireless communication. The apparatus may include means for receiving compressed CSI that is compressed in a frequency domain. The apparatus may include means for decompressing the compressed CSI using a model to obtain channel information. The apparatus may include means for configuring a communication based at least in part on the channel information.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of channel state information (CSI) reference signal (CSI-RS) beam management procedures, in accordance with the present disclosure.

FIG. 5 is a diagram illustrating examples of end-to-end CSI compression, in accordance with the present disclosure.

FIG. 6 is a diagram illustrating an example of hybrid CSI compression, in accordance with the present disclosure.

FIG. 7 is a diagram illustrating an example of signaling associated with compressed CSI feedback, in accordance with the present disclosure.

FIG. 8 is a diagram illustrating an example associated with an autoencoder for CSI compression, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

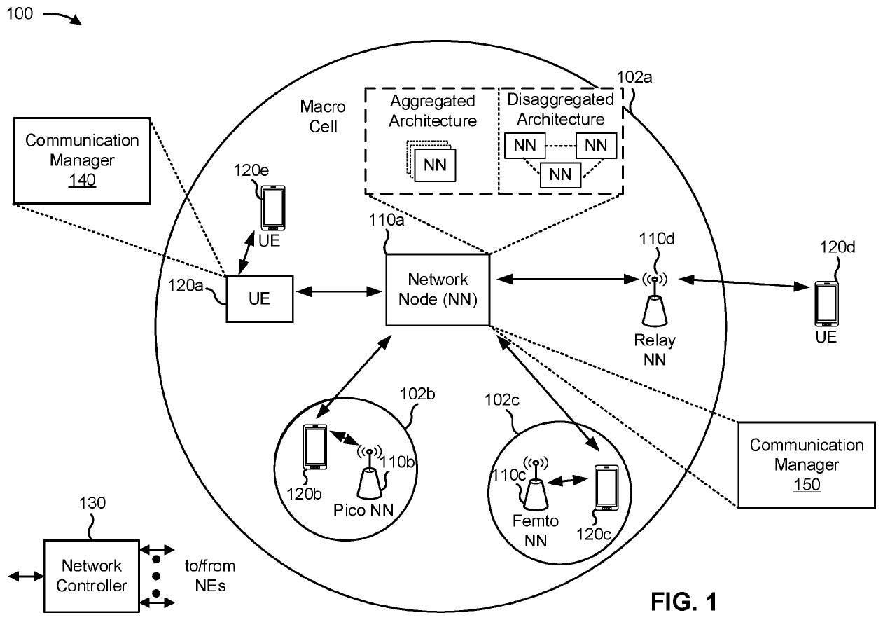

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network entities, such as one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network entities. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 includes two or more non-co-located network nodes. A disaggregated network node may be configured to utilize a protocol stack that is physically or logically distributed among two or more nodes (such as one or more central units (CUs), one or more distributed units (DUs), or one or more radio units (RUS)).

In some examples, a network node 110 includes an entity that communicates with UEs 120 via a radio access link, such as an RU. In some examples, a network node 110 includes an entity that communicates with other network nodes 110 via a fronthaul link or a midhaul link, such as a DU. In some examples, a network node 110 includes an entity that communicates with other network nodes 110 via a midhaul link or a core network via a backhaul link, such as a CU. In some examples, a network node 110 (such as an aggregated network node 110 or a disaggregated network node 110) may include multiple network entities, such as one or more RUs, one or more CUs, or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network entities, pico network entities, femto network entities, or relay network entities. These different types of network nodes 110 may have different transmit power levels, different coverage areas, or different impacts on interference in the wireless network 100. For example, macro network entities may have a high transmit power level (for example, 5 to 40 watts) whereas pico network entities, femto network entities, and relay network entities may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IOT (narrowband IoT) devices. Some UEs 120 may be considered a Customer Premises Equipment. A UE 120 may be included inside a housing 284 that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FRI characteristics or FR2characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4,FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may identify channel information based at least in part on a set of channel state information reference signals (CSI-RSs); generate compressed channel state information (CSI) using a model, wherein an input of the neural network model is based at least in part on the channel information, and wherein the compressed CSI is compressed in a frequency domain; and transmit the compressed CSI. Additionally, or alternatively, the communication manager 140 may perform one or more other operations described herein.

In some aspects, the network node 110 may include a communication manager 150. As described in more detail elsewhere herein, the communication manager 150 may receive compressed CSI that is compressed in a frequency domain; decompress the compressed CSI using a model to obtain channel information; and configure a communication based at least in part on the channel information. Additionally, or alternatively, the communication manager 150 may perform one or more other operations described herein.

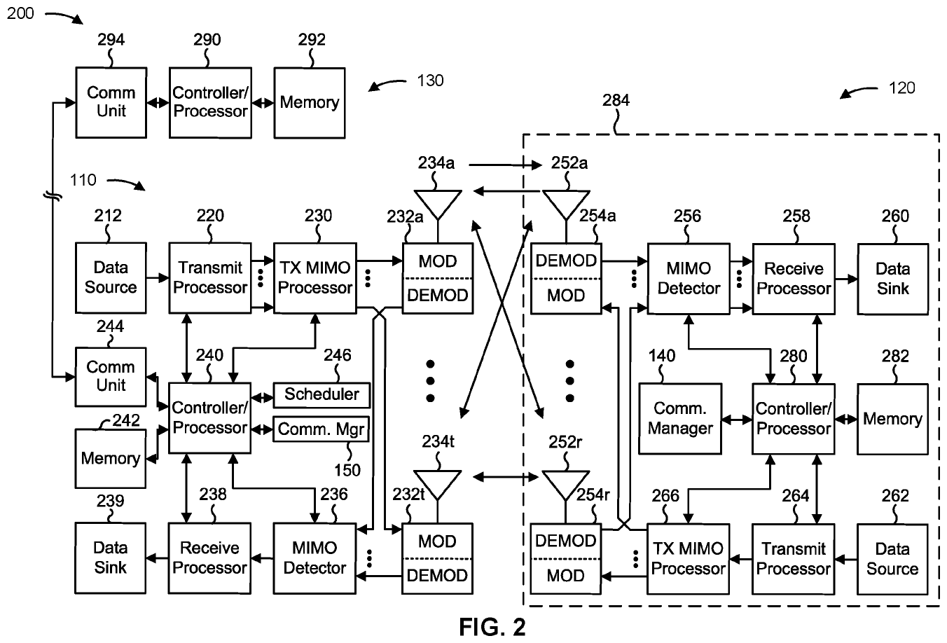

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, Toutput symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

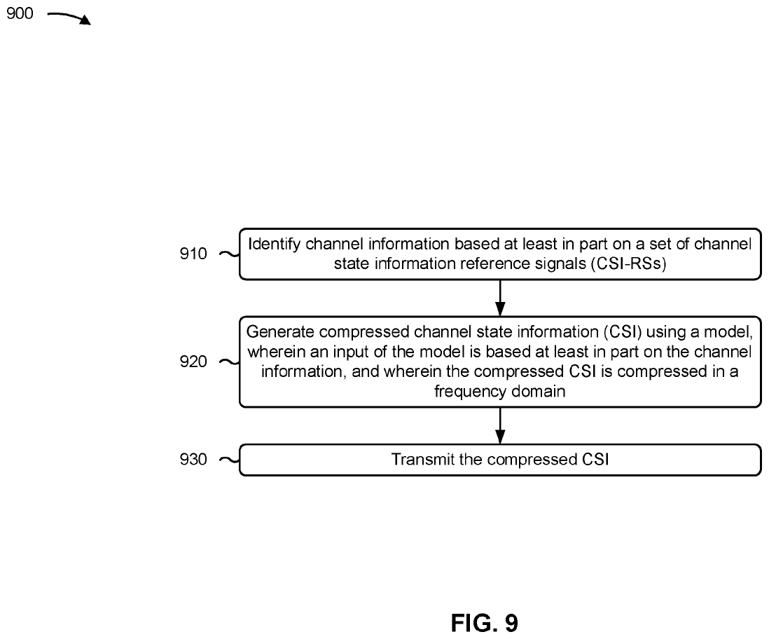

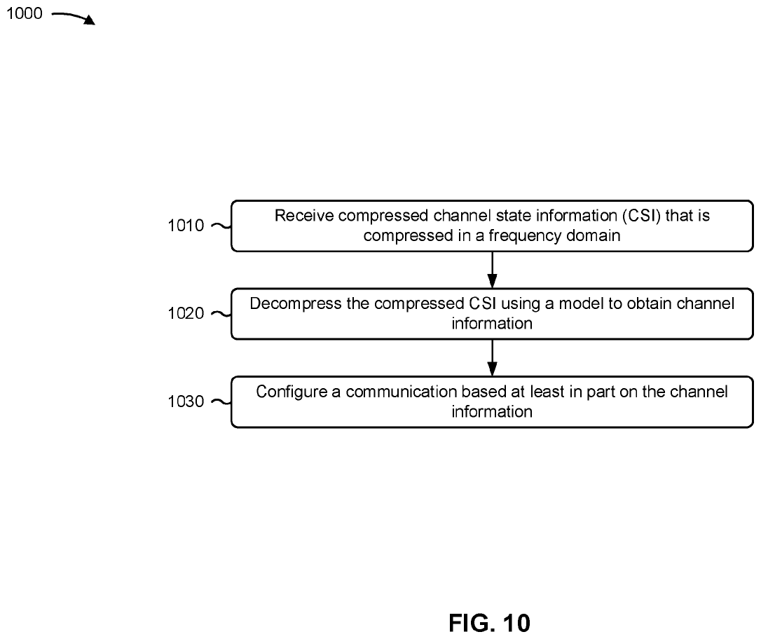

The controller/processor 240 of the network node 110, the controller/processor 280 of the UE 120, or any other component(s) of FIG. 2 may perform one or more techniques associated with CSI reporting, as described in more detail elsewhere herein. For example, the controller/processor 240 of the network node 110, the controller/processor 280 of the UE 120, or any other component(s) (or combinations of components) of FIG. 2 may perform or direct operations of, for example, process 900 of FIG. 9, process 1000 of FIG. 10, or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, or other processes as described herein. In some examples, executing instructions may include running the instructions, converting the instructions, compiling the instructions, or interpreting the instructions.

In some aspects, the UE 120 includes means for identifying channel information based at least in part on a set of CSI-RSs; means for generating compressed CSI using a model, wherein an input of the neural network model is based at least in part on the channel information, and wherein the compressed CSI is compressed in a frequency domain; and/or means for transmitting the compressed CSI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for receiving compressed CSI that is compressed in a frequency domain, means for decompressing the compressed CSI using a model to obtain channel information; and/or means for configuring a communication based at least in part on the channel information. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described with respect to the blocks may be implemented in a single hardware, software, or combination component or in various combinations of components. For example, the functions described with respect to the transmit processor 264, the receive processor 258, the TX MIMO processor 266, or another processor may be performed by or under the control of the controller/processor 280.

Deployment of communication systems, such as 5G NR systems, may be arranged in multiple manners with various components or constituent parts. In a 5G NR system, or network, a network node, a network node, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

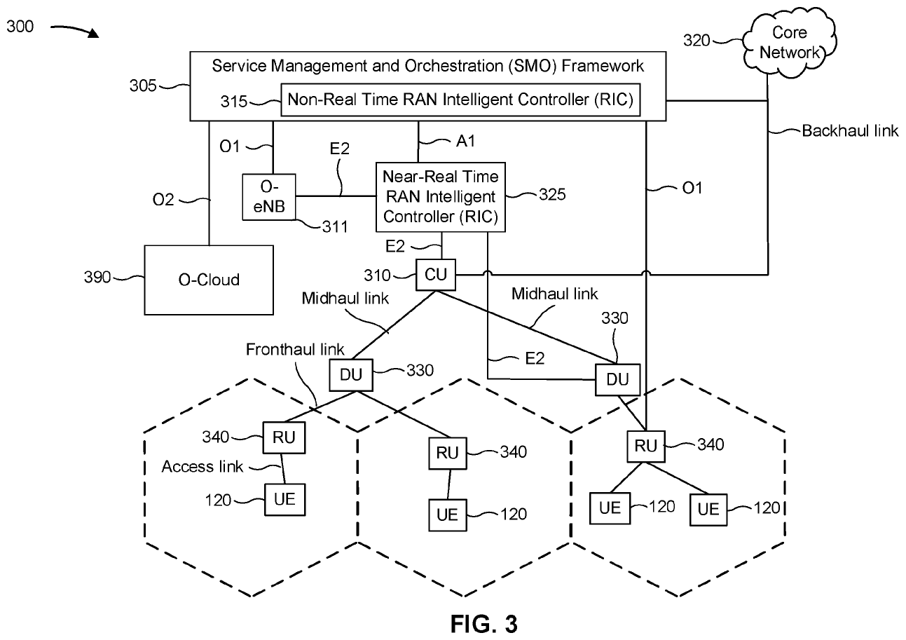

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an 01 interface) or via creation of RAN management policies (such as Al interface policies).

As indicated above, FIG. 3 is provided as an example. Other examples may differ from what is described with regard to FIG. 3.

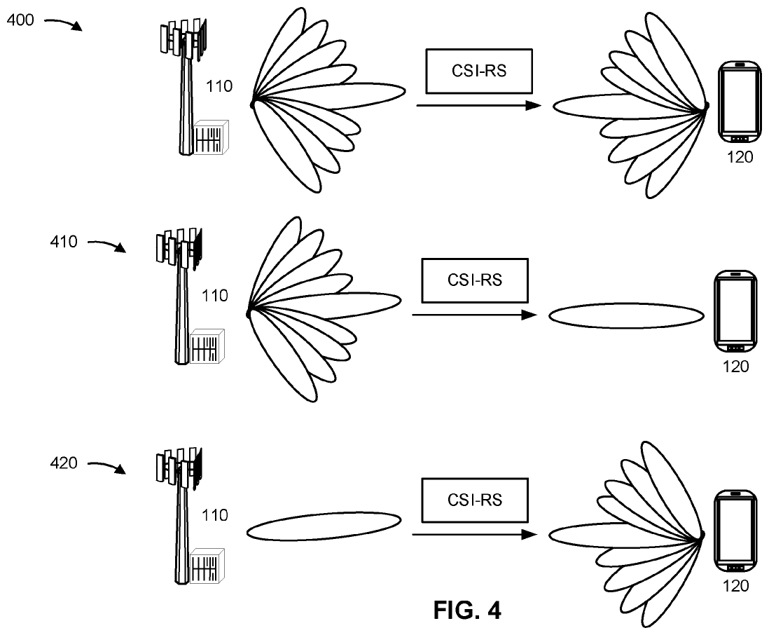

FIG. 4 is a diagram illustrating examples 400, 410, and 420 of CSI-RS beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

In some examples described here, reporting of information regarding the CSI-RS may involve compression and decompression of CSI, for example, using an autoencoder.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

A UE 120 may measure CSI-RSs and transmit a CSI report that indicates CSI that is determined based at least in part on the CSI-RSs. The CSI provides information regarding a channel such that a network node 110 can manage the connection between the network node 110 and the UE 120. In general, a channel may be represented by a channel matrix (generally represented by the variable H). The channel matrix may, for instance, represent a channel in the time domain (generally referred to as a channel impulse response) or in the frequency domain (generally referred to as a channel frequency response) or a combination thereof. Further representations, such as in the delay Doppler domain, can also be used. In the present disclosure, “channel information” (in contrast to “channel state information”) refers to an uncompressed (e.g., raw or unprocessed) characterization or representation or state of a channel, such as the above mentioned representations by a channel matrix. The channel information may further refer to information derived from the raw channel without loss of dimensionality/dimension reduction. As a consequence, the channel information may comprise sufficient information to allow deriving the channel matrix from the channel information without loss of accuracy. In this context, it is noted that the channel matrix itself may not be perfectly known, but merely estimated. Furthermore, a rank of the channel matrix may not be full (e.g., due to correlation between the transmit-receive paths). For frequency domain compression, the channel information may be based on a channel frequency response. In other words, the channel matrix may represent the channel in the frequency domain.

In time-division duplex (TDD) systems, channels in the uplink (UL) and downlink (DL) directions are the same, hence, a transmitter (e.g., a gNB) can deduce the (e.g., DL) CSI from respective (e.g., UL) pilots. This deduction is sometimes referred to as implicit feedback. In frequency-division duplex (FDD) systems, however, explicit feedback is generally required as reciprocity between UL and DL channels cannot be guaranteed. For DL CSI, for instance, the UE may measure CSI-RSs and transmit a CSI report that indicates CSI to the transmitter (e.g., a gNB).

CSI included in a CSI report may comprise processed channel information which reduces the amount of (UL) data involved in the CSI feedback compared to feedback of the complete channel information. Such feedback of processed channel information is sometimes referred to as implicit CSI feedback and is, for instance, broadly used in LTE systems where it can give a satisfactory performance.

For example, in some systems (such as systems utilizing beamformed communication) the CSI may indicate a set of beams selected by the UE 120, or may include information that facilitates the selection of beams or communication parameters by the network node 110. The information included in a CSI report may include a channel quality indicator (CQI), a rank indicator (RI), a W₁ codebook payload, and/or a precoding matrix indicator (PMI), among other examples. The CQI may indicate downlink radio conditions for a bandwidth part, such as in terms of a signal-to-interference-plus-noise ratio (SINR). The RI may indicate a requested number of MIMO layers for the UE 120. A W₁ codebook payload may indicate a selected set of L beams from an oversampled codebook, and may further indicate a subspace defined by L beams per polarization.

In NR Rel. 15, NR Type-II codebook CSI was standardized which could offer substantial gain over LTE codebooks, at the cost of a significant increase in UL overhead. In order to reap the benefits of an increased number of antenna ports, advanced precoding schemes such as non-linear precoding or multi-TRP transmission may be used. For these advanced schemes, highly accurate CSI feedback is needed. In other words, so-called explicit CSI feedback may be desirable which may allow deriving the original channel matrix (as measured, determined, or estimated at the UE) from the CSI feedback with little or no loss of information. In an ideal scenario, the complete channel information (e.g., channel matrix) would be fed back by the UE.

Explicit CSI feedback may be associated with significant overhead. For example, sub-band information, which may be provided as part of a Type-II codebook, described below, may have a large payload. The large size and complexity of (e.g., explicit) CSI in view of limited UL channel capacity may limit the implementation of more complex forms of CSI, thereby limiting gains in feedback reporting and usage. Furthermore, the transmission of large CSI may use significant UE and network resources.

Some techniques described herein enable compression and decompression of CSI, in the frequency domain, using a model such as an artificial neural network model. In some examples, the compression in the frequency domain may occur after transforming a channel impulse response (CIR), which was measured, determined, or estimated at the UE, into a channel frequency response (CFR), e.g., via a fast Fourier transform (FFT). Thus, overhead associated with transmission and reception of CSI is reduced. Some techniques described herein enable compression and decompression of CSI including explicit CSI and/or implicit CSI as described above and according to the specific examples of the present disclosure. Some techniques described herein provide frequency domain compression of CQI, RI, and/or PMI, such as by using an artificial neural network model. In some aspects described herein, the output of the artificial neural network model may replace one or more of the CQI, the RI, the W₁ codebook payload, or the PMI. For example, the compressed CSI may include one or more of the CQI, the RI, the W₁ codebook payload, or the PMI.

In some aspects, the compression and decompression use an autoencoder, which is a type of neural network used to learn efficient codings and decodings of unlabeled data. The usage of the autoencoder may improve efficiency of compression and decompression relative to some other techniques.

Compression in the frequency domain may be beneficial relative to compression in other domains (such as the time domain) because a scheduler often schedules communications at the sub-band granularity, so frequency domain compression may provide satisfactory compression results for sub-band granularity scheduling, among other benefits.

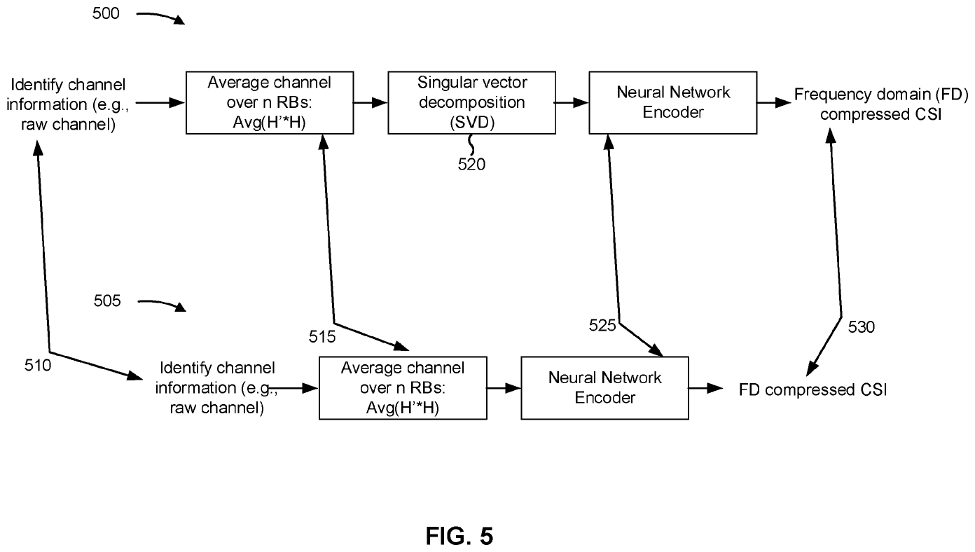

FIG. 5 is a diagram illustrating examples 500 and 505 of end-to-end CSI compression, in accordance with the present disclosure.

Examples 500 and 505 show end-to-end compression of CSI. As shown by reference number 510, the UE 120 may identify channel information, which may include a channel matrix (generally represented by H). For example, the UE 120 may identify a raw channel by measuring a set of CSI-RSs transmitted by a network node 110. In some examples, the channel information may be associated with a number of antennas, CSI ports, and/or RBs. For example, the set of CSI-RSs may be associated with a first number (e.g., 4) of receive ports and a second number (e.g., 32) CSI-RS ports, and may be spread across a third number of RBs (e.g., 50 RBs, in some examples). In one example, the raw channel may be of size 4×32 ×50. As mentioned above, the channel information may refer to information derived from the raw channel without loss of dimensionality (i.e., the channel information, e.g., channel matrix, in the present example, may be of size 4×32×50).

In some aspects, the UE 120 may process the raw channel. For example, the UE 120 may pre-whiten the raw channel based at least in part on observed interference before averaging.

In some aspects, as shown by reference number 515, the UE may average the channel information. For example, the UE may average the raw channel (e.g., channel matrix or CFR) over n RBs. For example, the UE may average the channel information, e.g., the raw channel, over a plurality of RBs carrying CSI-RSs. The plurality of RBs over which the channel information is averaged may be a subset of a set of RBs used for transmitting CSI-RSs, e.g., according to any of the beam management procedures of FIG. 4. In some examples, the parameter n may indicate a granularity for averaging the raw channel (channel matrix or CFR). For example, if there are 50 total RBs associated with the raw channel, and a granularity of n=25 is used, the UE 120 may separately average the raw channel across a first group of 25 RBs and a second group of 25 RBs, thereby simplifying compression of the channel information. In the present example, the averaging reduces the dimensionality by a factor of 25. In other words, the averaged channel information is reduced in size from 4×32×50 to 4×32×2, significantly reducing the overhead. Thus, the UE 120 may perform compression over n RBs. The averaging of the channel information may include calculating the average Avg (H^{H}H) where H^{H} is the conjugate transpose of H. In some aspects, the UE 120 may not average the channel information. For example, the UE 120 may perform per-RB compression. In other words, the input to the artificial neural network encoder may include the (unaveraged) channel information as shown in example 505 in FIG. 5.

In example 500, the UE 120 performs singular value decomposition (SVD) on the channel information (e.g., the channel matrix H, the square channel matrix H^{H} or the averaged channel information Avg(H^{H})), as shown by reference number 520. SVD is a factorization of a matrix (e.g., the channel matrix). The SVD of an m×n complex matrix M is a factorization of the form M=UΣV^{H}, where U is an m×m complex unitary matrix, Σ is an m×n rectangular diagonal matrix with non-negative real numbers on the diagonal, and V is an n×n complex unitary matrix. The diagonal entries of Σ are referred to as the singular values of M. The columns of U are referred to as left singular vectors of M. The columns of V are referred to as right singular vectors of M. The left singular vectors form a set of orthonormal bases, and the right singular vectors form a set of orthonormal bases. The right singular vectors post SVD may be referred to herein as beamformers or SVD beams. The right singular vectors may indicate a set of beams derived from the channel information. In example 505, the UE 120 does not perform (i.e., omits) SVD on the channel information. Performing SVD may provide more granular CSI than providing implicit feedback, whereas not performing SVD may conserve processing resources at the UE 120.

As shown by reference number 525, the UE may provide an input to the model. The input may be based at least in part on the channel information. For example, in example 500, the input to the model may include one or more (e.g., all of) the SVD beams generated based at least in part on the channel information, as shown in association with reference number 520. As another example, in example 505, the input to the model may include the channel information (e.g., the averaged channel matrix, an unaveraged channel matrix such as the raw channel, or the like). In some aspects, the input to the model may include one or more (e.g., all) of the singular values of the SVD. In examples 500 and 505, the model comprises or is an artificial neural network encoder, described in more detail below.

As shown by reference number 530, the model may output compressed CSI. Thus, the UE 120 may generate compressed CSI. The CSI may be compressed in the frequency domain, as described above. In some aspects, the model may use positional encoding to identify each sub-band included in the compressed CSI. A final linear layer of the model, which performs the compression of the CSI, may work across the sub-band (e.g., frequency) dimension as well as the gNB antenna dimension. The model may generate a dimensionally-reduced version of the CSI such that the CSI is compressed in the frequency domain. The compressed CSI may include a compressed version of the SVD beams (in example 500), or a compressed version of the channel information (in example 505). The UE 120 may transmit the compressed CSI to the network node 110.

In some aspects, the compressed CSI may include a PMI payload. For example, the compressed CSI, once decompressed by the network node 110, may indicate a set of precoders or one or more PMIs. In this example, the output of the model may be a compressed version of the set of precoders or the one or more PMIs. For example, the output of the model may provide one or more PMIs and/or one or more precoders derived from a set of singular vectors (e.g., right singular vectors) determined based at least in part on the channel information used to generate the compressed CSI. In some aspects, the compressed CSI may include a PMI payload and a W₁ codebook payload. For example (e.g., in example 500), the compressed CSI, once decompressed by the network node 110, may indicate a set of precoders, one or more PMIs, a choice of a DFT oversampled codebook, and/or a subspace defined by L beams per polarization. In this example, the output of the model may be a compressed version of a set of precoders, one or more PMIs, a choice of a DFT oversampled codebook, and/or a subspace defined by L beams per polarization. In some aspects, the compressed CSI may include a PMI payload, a W₁ codebook payload, a CQI, and an RI. For example (e.g., in example 505), the compressed CSI, once decompressed by the network node 110, may indicate the set of precoders, the PMI payload, the W₁ codebook payload, the CQI, and the RI.

In some aspects, the compressed CSI may include one or more singular values, derived from the channel matrix or the averaged channel matrix via SVD. The one or more singular values may be the dominant (largest) singular values resulting from the SVD. For example, the UE 120 may transmit, and the network node 110 may receive, the one or more singular values. In some aspects, the UE 120 may transmit wideband and/or subband CQI values of the CSI in addition to the one or more singular values. Additionally, or alternatively, the UE 120 may transmit one or more PMI values and/or one or more RI values in addition to the one or more singular values. In some aspects, the UE 120 may transmit the one or more singular values without transmitting wideband and/or subband CQI values. In some aspects, the one or more singular values may be considered wideband and/or subband CQI values. In some aspects, the singular values may be differentially encoded, such as relative to a baseline value. In some aspects, the UE 120 may quantize the singular values. For example, the network node 110 may transmit, and the UE 120 may receive, information indicating a quantization for the singular values. The UE 120 may quantize the singular values in accordance with the quantization.

The network node 110 may decompress the compressed CSI. For example, the network node 110 may use a model (e.g., an artificial neural network model) to decompress the compressed CSI. In some aspects, the model used by the network node 110 and the model used by the UE 120 may be associated with an autoencoder, as described elsewhere herein. Thus, the network node 110 can recover the CSI transmitted by the UE 120. The network node 110 may communicate based at least in part on the decompressed CSI. For example, the network node 110 may schedule communications with the UE 120, or configure the UE 120 for communications, based at least in part on the decompressed CSI.

As indicated above, FIG. 5 is provided as an example. Other examples may differ from what is described with regard to FIG. 5.

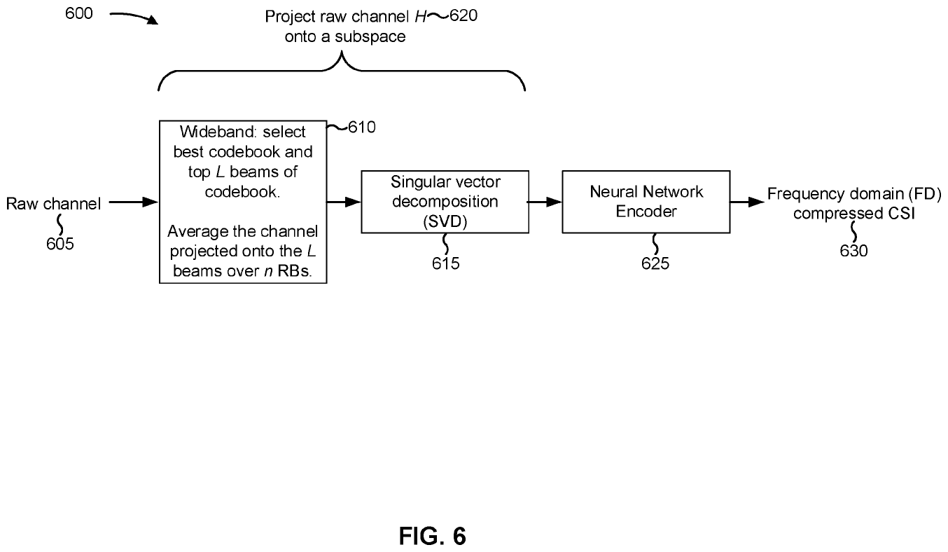

FIG. 6 is a diagram illustrating an example 600 of hybrid CSI compression, in accordance with the present disclosure. The operations of example 600 may be performed by a UE 120. Example 600 is referred to as hybrid CSI compression because example 600 incorporates aspects of enhanced Type-II (eType-II) CSI feedback as well as model-based compression of CSI feedback. The CSI report may include a codebook, which is a set of precoders or one or more PMIs. A Type-I codebook may include predefined matrices. A Type-II codebook may include a more detailed CSI report for multi-user MIMO and may include a group of beams. In some cases, the Type II CSI feedback may use a compressed Type II precoder. This may reduce overhead of Type II CSI feedback. The compressed precoder may exploit the sparsity of the spatial domain and/or the frequency domain. Procedures for eType-II CSI feedback, including the eType-II CSI codebook, compression methods, and reporting, are defined in Release 17 of 3GPP Technical Specification (TS) 38.214, such as at Sections 5.2.2.2.5 and 5.2.2.2.6.

As shown in FIG. 6, and by reference number 605, the UE 120 may identify channel information, which may include a channel matrix (generally represented by H). For example, the UE 120 may identify a raw channel by measuring a set of CSI-RSs transmitted by a network node 110. In some examples, the channel information may be associated with a number of antennas, CSI ports, and/or RBs. For example, the set of CSI-RSs may be associated with 4 receive ports and 32 CSI-RS ports, and may be spread across a number of RBs (e.g., 50 RBs, in some examples). Thus, the raw channel may be of size 4×32×50. In some aspects, the UE 120 may process the raw channel. For example, the UE 120 may pre-whiten the raw channel based at least in part on observed interference before averaging.

In some aspects, as shown by reference number 610, the UE may select a best codebook and a top L beams of the codebook (where Z is an integer) for the wideband. For example, the UE 120 may select the top L beams based at least in part on CSI-RS measurements associated with the top Z beams. Furthermore, the UE may average the channel, as projected onto the top L beams, over n RBs. The projection onto the top L beams reduces a (spatial) dimension of the channel (information), thereby reducing the overhead of CSI signaling. The parameter n may indicate a granularity for averaging the raw channel. For example, if there are 50 total RBs associated with the raw channel, and a granularity of n=25 is used, the UE 120 may separately average the projected channel across a first group of 25 RBs and a second group of 25 RBs, thereby simplifying compression of the channel information. Thus, the UE 120 may perform compression over n RBs. The averaging of the projected channel information may include calculating the average Avg((HB)^{H}(HB)) where (HB) represents the projection of the channel H onto the top Z beams. In some aspects, the UE 120 may not average the projected channel (information). For example, the UE 120 may perform per-RB compression.

As shown by reference number 615, in some aspects, the UE 120 performs SVD on the channel information after projection (e.g., the averaged channel information). As mentioned above, the SVD of an m x n complex matrix M is a factorization of the form M=UΣV^{H}, where U is an m x m complex unitary matrix, Σ is an m×n rectangular diagonal matrix with non-negative real numbers on the diagonal, and Vis an n×n complex unitary matrix. The diagonal entries of Σ are referred to as the singular values of M. The columns of U are referred to as left singular vectors of M. The columns of V are referred to as right singular vectors (e.g., beamformers, SVD beams) of M. As shown by reference number 620, finding the best codebook, selecting the top L beams of the best codebook, projecting the raw channel (e.g., channel matrix) onto the L beams, i.e. a subspace, averaging the projected channel, and/or performing SVD on the averaged projected channel may be referred to herein for simplicity as projecting the channel H onto a subspace. Thus, the UE 120 may project the received channel onto a subspace. The projection of the received channel may be of a lower dimension than the channel matrix of the received channel.

As shown by reference number 625, the UE may provide an input to the model, e.g., an artificial neural network. The input may be based at least in part on the projected channel information. For example, in example 600, the input to the model may include the averaged projected channel, which was projected onto the top L beams of the best codebook. In some aspects (e.g., for Type-II CSI), the input may be a raw channel of a subspace HW₁ (e.g., the UE 120 may not perform SVD on the (averaged or unaveraged) projected channel information). In some aspects (e.g., for Type-II CSI), the input may be a set of SVD beams of the subspace HW₁ (with or without averaging). In some aspects, (e.g., for eType-II CSI), the input may be a raw channel of a subspace HW₁W_{f} (e.g., the UE 120 may not perform SVD on the (averaged or unaveraged) projected channel information)). In some aspects, (e.g., for eType-II CSI), the input may be a set of SVD beams of the subspace HW₁W_{f} (with or without averaging). In some aspects, (e.g., for Doppler CSI), the input may be a raw channel of a subspace HW₁W_{f}Wₜ (e.g., the UE 120 may not perform SVD on the (averaged or unaveraged) projected channel information). In some aspects, (e.g., for Doppler CSI), the input may be a set of SVD beams of the subspace HW₁W_{f}Wₜ. Doppler CSI may include time-domain correlation or Doppler-domain information, represented by Wₜ, to assist in downlink precoding. Thus, in some aspects, the input of the model is based at least in part on a matrix (W_{f}) containing one or more frequency-domain bases derived from the channel information.

As shown by reference number 630, the model may output compressed CSI. Thus, the UE 120 may generate compressed CSI. The CSI may be compressed in the frequency domain, as described above. For example, the model may generate a dimensionally reduced version of the CSI such that the CSI is compressed in the frequency domain. The compressed CSI may include a compressed version of the SVD beams or a compressed version of the projected channel information. The UE 120 may transmit the compressed CSI to the network node 110. In some aspects, the compressed CSI may include a PMI payload. For example, the compressed CSI, once decompressed by the network node 110, may indicate a set of precoders or one or more PMIs. In this example, the output of the model may be a compressed version of the set of precoders or the one or more PMIs.

In some aspects, the compressed CSI may include one or more singular values, derived from the channel matrix or the averaged channel matrix after projection onto the subspace via SVD. The one or more singular values may be the dominant (largest) singular values resulting from the SVD. For example, the UE 120 may transmit, and the network node 110 may receive, the one or more singular values. In some aspects, the UE 120 may transmit wideband and/or subband CQI values of the CSI (and/or PMI, and/or RI) in addition to the one or more singular values. In some aspects, the UE 120 may transmit the one or more singular values without transmitting wideband and/or subband CQI values. In some aspects, the one or more singular values may be considered wideband and/or subband CQI values. In some aspects, the singular values may be differentially encoded, such as relative to a baseline value. In some aspects, the UE 120 may quantize the singular values. For example, the network node 110 may transmit, and the UE 120 may receive, information indicating a quantization for the singular values. The UE 120 may quantize the singular values in accordance with the quantization.

The network node 110 may decompress the compressed CSI. For example, the network node 110 may use a model (e.g., a neural network model) to decompress the compressed CSI. In some aspects, the model used by the network node 110 and the model used by the UE 120 may be associated with an autoencoder, as described elsewhere herein. Thus, the network node 110 can recover the CSI transmitted by the UE 120. The network node 110 may communicate based at least in part on the decompressed CSI. For example, the network node 110 may schedule communications with the UE 120, or configure the UE 120 for communications, based at least in part on the decompressed CSI.

As indicated above, FIG. 6 is provided as an example. Other examples may differ from what is described with regard to FIG. 6.

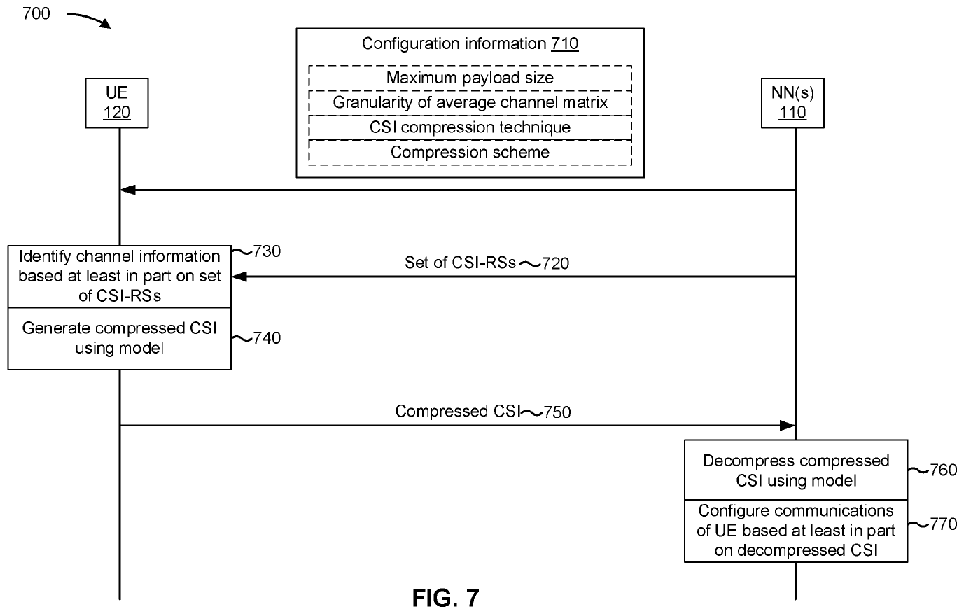

FIG. 7 is a diagram illustrating an example 700 of signaling associated with compressed CSI feedback, in accordance with the present disclosure. As shown, example 700 includes a UE 120 and a network node 110. In some aspects, different operations of example 700 may be performed by different network nodes 110. For example, a first network node 110 may transmit configuration information, and a second network node 110 may transmit a set of CSI-RSs.

As shown by reference number 710, the network node 110 may transmit, and the UE 120 may receive, configuration information. The configuration information can be signaled via radio resource control (RRC) signaling, medium access control (MAC) signaling, downlink control information (DCI), system information, or a combination thereof. While example 700 illustrates a single transmission of configuration information, in some aspects, the configuration information may be transmitted via multiple different transmissions (e.g., different parts of the configuration information may be transmitted in different transmissions). The configuration information may include one or more parameters, which are illustrated in example 700 by dashed boxes.

In some aspects, the configuration information may include information indicating a maximum payload size for CSI. For example, the configuration information may indicate a maximum payload size of the compressed CSI, or a maximum payload size of a CSI report carrying compressed CSI. In some aspects, the UE 120 may determine one or more parameters for compressing the CSI based at least in part on the maximum payload size. For example, the UE 120 may determine a dimension of an output of the model based at least in part on the maximum payload size (e.g., such that the maximum payload size is not exceeded by the output of the model). As another example, the UE 120 may determine a quantization of an output of the model based at least in part on the maximum payload size (e.g., such that the quantized output of the model does not exceed the maximum payload size). In some aspects, the configuration information may include a set of parameters for a model. For example, the configuration information may indicate a set of parameters of an artificial neural network model, such as a quantization, a dimension, a hyperparameter of the neural network model (e.g., a parameter indicating a structure of the neural network model), or the like.

In some aspects, the configuration information may include an indication of a granularity of an average channel matrix. For example, the configuration may indicate a number n of RBs over which the UE 120 should average the channel matrix (e.g., the raw channel), as described in more detail in connection with FIGS. 5 and 6.

In some aspects, the configuration information may indicate a CSI compression technique for the CSI. For example, the configuration information may indicate whether the UE 120 should generate eType-II CSI, compressed CSI using end-to-end compression (as in example 500 or example 505), or compressed CSI using hybrid compression (as in example 600). As another example, the configuration information may indicate whether or not to perform SVD. The UE 120 may compress the CSI, and the network node 110 may decompress the CSI, in accordance with the indicated CSI compression technique.

In some aspects, the configuration information may indicate a compression scheme associated with one or more (DL) layers of the CSI. For example, CSI associated with a larger number of layers has a larger payload than CSI associated with a smaller number of layers. The UE 120 may compress the CSI based at least in part on a rank associated with the CSI. For example, the payload size of the compressed CSI may be fixed irrespective of the rank associated with the CSI, which simplifies uplink scheduling. As another example, each layer of the compressed CSI may have the same payload size, such that the payload size of the compressed CSI increases linearly with the rank of the CSI. As another example, there may be a first payload size for a CSI with a rank 1, and a second payload size for a CSI with a rank greater than 1 (or more generally, a first payload size for a CSI of rank 1 through X, and a second payload size for a CSI with a rank greater than X, where X is a rank threshold). In this example, the first payload size, the second payload size, a relationship between the first payload size and the second payload size, and/or a value of the rank threshold may be configured by the network node 110. In some aspects, the configuration information may indicate a parameter associated with joint compression of multiple layers, such as a payload size. In some aspects, the configuration information may indicate a parameter associated with individual compression of one or more layers (e.g., one or more V vectors of the CSI), such as relative to a strongest layer (e.g., a strongest V vector). For example, the parameter associated with individual compression of the one or more layers may indicate a compression accuracy that is lower than a compression accuracy of the strongest layer.

The compressed CSI may be associated with an indexing configuration. The indexing configuration may indicate how elements of the input to the model (such as elements of the raw channel's channel matrix, elements of an averaged channel matrix, elements of a right singular vector, or elements of an SVD) are identified by indexes. In some aspects, the indexing configuration may indicate that a receive antenna index, then a CSI-RS transmit port index, then a subband index are used to identify elements of the input to the model (such as when the raw channel is inputted to the model). In some aspects, the indexing configuration may indicate that a layer index, then a CSI-RS transmit port index, then a subband index are used to identify elements of the input to the model (such as when the beamformers are input to the model).

As shown by reference number 720, the network node 110 may transmit a set of CSI-RSs. The set of CSI-RSs may be transmitted in one or more RBs. As shown by reference number 730, the UE 120 may identify (e.g., measure, determine, or estimate) channel information (e.g., a raw channel) based at least in part on the set of CSI-RSs.

As shown by reference number 740, the UE 120 may generate compressed CSI using a model. The UE 120 may generate the compressed CSI according to one or more parameters indicated by the configuration information indicated by reference number 710. The generation of the compressed CSI is described in more detail in connection with FIGS. 5 and 6.

As shown by reference number 750, the UE 120 may transmit, and the network node 110 may receive, the compressed CSI. For example, the UE 120 may transmit a CSI report including the compressed CSI. In some aspects, the CSI report may include the compressed CSI and one or more CSI parameters other than the compressed CSI (such as an RI, a CQI, a W1 codebook payload, or the like). In some aspects, the CSI report may include only the compressed CSI (e.g., all CSI parameters may be provided via the compressed CSI).

As shown by reference number 760, the network node 110 may decompress the compressed CSI. In some aspects, the network node 110 may decompress the compressed CSI using a model, such as an artificial neural network decoder associated with the artificial neural network encoder used to compress the CSI. The artificial neural network decoder may be associated with the artificial neural network encoder based on the artificial neural network decoder and the artificial neural network encoder forming an autoencoder.

As shown by reference number 770, the network node 110 may configure communications of the UE 120 based at least in part on the decompressed CSI. For example, the network node 110 may select one or more beams for the UE 120, one or more communication parameters for the UE 120, or the like.

In this way, CSI is compressed and then decompressed (such using an autoencoder), which reduces overhead associated with CSI transmission and increases the amount of data that can be conveyed via CSI at a given level of overhead.

As indicated above, FIG. 7 is provided as an example. Other examples may differ from what is described with regard to FIG. 7.

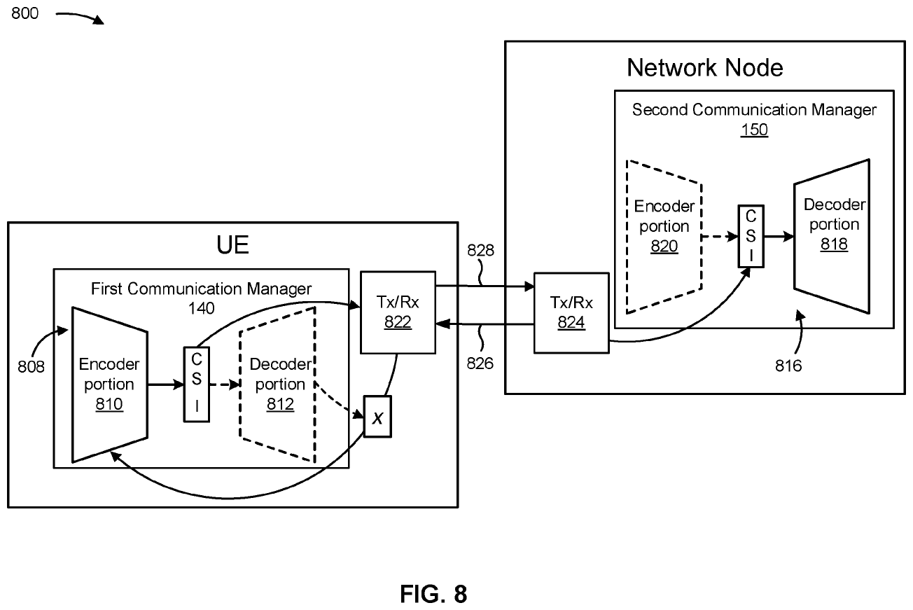

FIG. 8 is a diagram illustrating an example 800 associated with an autoencoder for CSI compression, in accordance with the present disclosure. As shown, a UE 120 may communicate with a network node 110. The UE 120 and the network node 110 may communicate with one another via a wireless network (e.g., the wireless network 100 shown in FIG. 1).

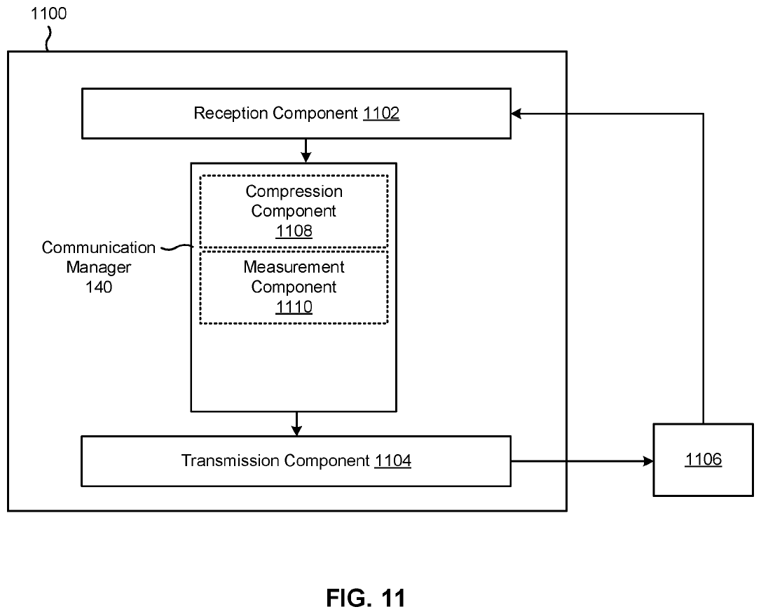

As shown, the UE 120 may include a communication manager 140 that may be configured to utilize an autoencoder 808 to perform one or more wireless communication tasks. The communication manager 140 may be configured to utilize any number of machine learning components not shown in FIG. 8. In some aspects, the communication manager 140 may be, include, or be included in, the compression component 1108 described below in connection with FIG. 11.

As shown, the autoencoder 808 may include an encoder portion 810 configured to receive an input, and to provide compressed CSI as output. The encoder portion 810 may be, or may be similar to, the model described with regard to reference number 740 of FIG. 7. The autoencoder 808 also may include a decoder portion 812 configured to receive the compressed CSI and to provide decompressed CSI (e.g., at least part of or an approximation of the input to the encoder portion 810) as output.

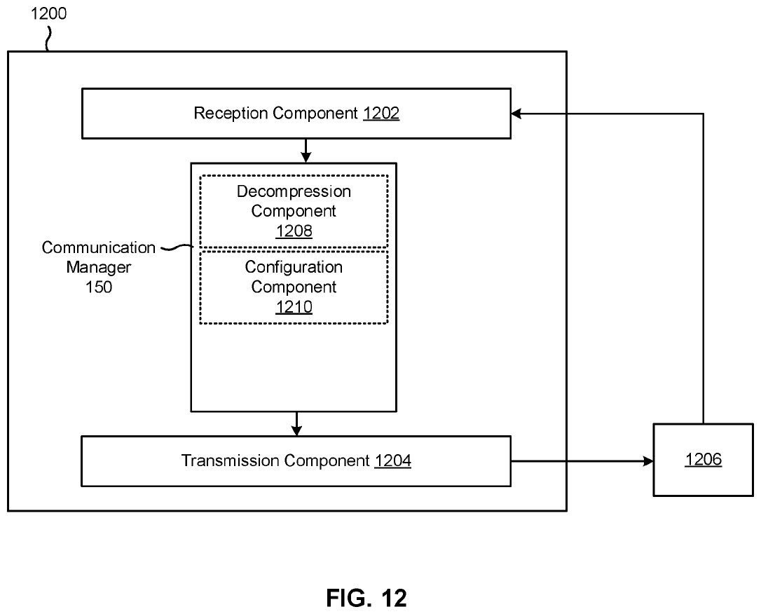

As shown in FIG. 8, the network node 110 may include a communication manager 150 that may be configured to utilize an autoencoder 816 to perform one or more wireless communication tasks. In some aspects, the communication manager 150 may be, include, or be included in, the decompression component 1208 described below in connection with FIG. 12. In some aspects, the autoencoder 816 may correspond to the autoencoder 808. In some aspects, the autoencoder 816 may be a copy of the autoencoder 808. In some aspects, the UE 120 may include only the encoder portion 810 and/or the network node 110 may include only a decoder portion 818 configured to receive the compressed CSI as input and to provide the decompressed CSI as output. The communication manager 150 may be configured to utilize any number of machine learning components not shown in FIG. 8. The autoencoder 816 may include an encoder portion 820 configured to receive an input and to provide compressed CSI as output.

As shown in FIG. 8, in some examples, the network node 110 may include or may be associated with a transceiver (shown as Tx/Rx 824) that may facilitate wireless communications with a transceiver 822 of the UE 120. In some aspects, the network node 110 may not include a transceiver that facilitates direct wireless communications with a UE 120. For example, the network node 110 may be associated with a radio unit that directly communicates with the UE 120. As shown by reference number 826, the network node 110 may transmit, using the transceiver 824, a wireless communication to the UE 120. The wireless communication may include, for example, the encoder portion 810 of the autoencoder 808 and/or the configuration information of FIG. 7. The transceiver 822 of the UE 120 may receive the wireless communication. The communication manager 140 may decode and instantiate the encoder portion 810.

As shown, the communication manager 140 may provide an input based at least in part on channel information to the encoder portion 810 of the autoencoder 808. The encoder portion 810 of the autoencoder 808 may determine compressed CSI. As shown, the communication manager 140 may provide the compressed CSI to the transceiver 822 for transmission. As shown by reference number 828, the transceiver 822 may transmit, and the transceiver 824 of the network node 110 may receive, the compressed CSI.

As shown, the communication manager 150 of the network node 110 may provide the compressed CSI as input to the decoder portion 818 of the autoencoder 816. The decoder portion 818 may determine (e.g., decompress, reconstruct, approximate) the CSI or the input to the encoder portion 810. In some aspects, the network node 110 may re-train the decoder portion 818 based at least in part on the CSI.

As indicated above, FIG. 8 is provided merely as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with frequency domain compression of channel state information.

As shown in FIG. 9, in some aspects, process 900 may include identifying channel information based at least in part on a set of channel state information reference signals (CSI-RSs) (block 910). For example, the UE (e.g., using communication manager 140 and/or measurement component 1110, depicted in FIG. 9) may identify channel information based at least in part on a set of channel state information reference signals (CSI-RSs), as described above.

As further shown in FIG. 9, in some aspects, process 900 may include generating compressed CSI using a model, wherein an input of the model is based at least in part on the channel information, and wherein the compressed CSI is compressed in a frequency domain (block 920). For example, the UE (e.g., using communication manager 140 and/or compression component 1108, depicted in FIG. 11) may generate compressed CSI using a model, wherein an input of the model is based at least in part on the channel information, and wherein the compressed CSI is compressed in a frequency domain, as described above.

As further shown in FIG. 9, in some aspects, process 900 may include transmitting the compressed CSI (block 930). For example, the UE (e.g., using communication manager 140 and/or transmission component 1104, depicted in FIG. 11) may transmit the compressed CSI, as described above.

Process 900 may include additional aspects, such as any single aspect or any combination of aspects described below and/or in connection with one or more other processes described elsewhere herein.

In a first aspect, the model is a neural network encoder.

In a second aspect, alone or in combination with the first aspect, the compressed CSI is based at least in part on right singular vectors associated with the channel information and omits left singular vectors associated with the channel information.

In a third aspect, alone or in combination with one or more of the first and second aspects, the channel information includes at least part of a singular value decomposition associated with a channel matrix.

In a fourth aspect, alone or in combination with one or more of the first through third aspects, the channel information includes a channel matrix.

In a fifth aspect, alone or in combination with one or more of the first through fourth aspects, the channel information includes at least part of a singular value decomposition associated with a projection of a channel matrix, wherein the projection is onto a set of top beams of a codebook.

In a sixth aspect, alone or in combination with one or more of the first through fifth aspects, the compressed CSI includes a precoding matrix indicator payload outputted by the model.

In a seventh aspect, alone or in combination with one or more of the first through sixth aspects, process 900 includes receiving information indicating a maximum payload size, wherein generating the compressed CSI is based at least in part on the maximum payload size.

In an eighth aspect, alone or in combination with one or more of the first through seventh aspects, process 900 includes receiving an indication of a granularity of an average channel matrix, wherein identifying the channel information further comprises generating the average channel matrix using the granularity.

In a ninth aspect, alone or in combination with one or more of the first through eighth aspects, process 900 includes receiving a set of parameters for the model, wherein generating the compressed CSI is based at least in part on the set of parameters.

In a tenth aspect, alone or in combination with one or more of the first through ninth aspects, the compressed CSI includes one or more singular values based at least in part on a channel matrix.

In an eleventh aspect, alone or in combination with one or more of the first through tenth aspects, a compression scheme for the compressed CSI is based at least in part on a number of layers associated with the compressed CSI.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110, a plurality of network nodes) performs operations associated with frequency domain compression of channel state information.

As shown in FIG. 10, in some aspects, process 1000 may include receiving compressed CSI that is compressed in a frequency domain (block 1010). For example, the network node (e.g., using communication manager 150 and/or reception component 1202, depicted in FIG. 12) may receive compressed CSI that is compressed in a frequency domain, as described above.

As further shown in FIG. 10, in some aspects, process 1000 may include decompressing the compressed CSI using a model to obtain channel information (block 1020). For example, the network node (e.g., using communication manager 150 and/or decompression component 1208, depicted in FIG. 12) may decompress the compressed CSI using a model to obtain channel information, as described above.

As further shown in FIG. 10, in some aspects, process 1000 may include configuring a communication based at least in part on the channel information (block 1030). For example, the network node (e.g., using communication manager 150 and/or configuration component 1210, depicted in FIG. 12) may configure a communication based at least in part on the channel information, as described above.

Process 1000 may include additional aspects, such as any single aspect or any combination of aspects described below and/or in connection with one or more other processes described elsewhere herein.

In a first aspect, the model is a neural network decoder.

In a second aspect, alone or in combination with the first aspect, the decompressed CSI is based at least in part on right singular vectors associated with the channel information and omits left singular vectors associated with the channel information.

In a third aspect, alone or in combination with one or more of the first and second aspects, the channel information includes at least part of a singular value decomposition associated with a channel matrix.

In a fourth aspect, alone or in combination with one or more of the first through third aspects, the channel information includes a channel matrix.

In a fifth aspect, alone or in combination with one or more of the first through fourth aspects, the channel information includes at least part of a singular value decomposition associated with a projection of a channel matrix, wherein the projection is onto a set of top beams of a codebook.

In a sixth aspect, alone or in combination with one or more of the first through fifth aspects, the compressed CSI includes a precoding matrix indicator payload.

In a seventh aspect, alone or in combination with one or more of the first through sixth aspects, process 1000 includes transmitting information indicating a maximum payload size, wherein the compressed CSI is based at least in part on the maximum payload size.

In an eighth aspect, alone or in combination with one or more of the first through seventh aspects, process 1000 includes transmitting an indication of a granularity of an average channel matrix of the channel information.

In a ninth aspect, alone or in combination with one or more of the first through eighth aspects, process 1000 includes transmitting a set of parameters for a neural network encoder associated with generating the compressed CSI.

In a tenth aspect, alone or in combination with one or more of the first through ninth aspects, the compressed CSI includes one or more singular values based at least in part on a channel matrix.

In an eleventh aspect, alone or in combination with one or more of the first through tenth aspects, a compression scheme for the compressed CSI is based at least in part on a number of layers associated with the compressed CSI.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a compression component 1108 or a measurement component 1110, among other examples.

In some aspects, the apparatus 1100 may be configured to perform one or more operations described herein in connection with FIGS. 3-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The measurement component 1110 may identify channel information based at least in part on a set of CSI-RSs. The compression component 1108 may generate compressed CSI using a model, wherein an input of the model is based at least in part on the channel information, and wherein the compressed CSI is compressed in a frequency domain. The transmission component 1104 may transmit the compressed CSI.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include one or more of a decompression component 1208 or a configuration component 1210, among other examples.

In some aspects, the apparatus 1200 may be configured to perform one or more operations described herein in connection with FIGS. 3-9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The reception component 1202 may receive compressed CSI that is compressed in a frequency domain. The decompression component 1208 may decompress the compressed CSI using a model to obtain channel information. The configuration component 1210 or the transmission component 1204 may configure a communication based at least in part on the channel information.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: identifying channel information based at least in part on a set of channel state information reference signals (CSI-RSs); generating compressed channel state information (CSI) using a neural network model, wherein an input of the neural network model is based at least in part on the channel information, and wherein the compressed CSI is compressed in a frequency domain; and transmitting the compressed CSI.

Aspect 2: The method of Aspect 1, wherein the channel information is based on a channel matrix representing a channel in the frequency domain.

Aspect 3: The method of any of Aspects 1-2, wherein the input of the neural network model is based at least in part on an average of the channel information across a set of resource blocks (RBs).

Aspect 4: The method of Aspect 3, further comprising: receiving an indication of a granularity indicating a number of RBs included in the set of RBs.

Aspect 5: The method of Aspect 3, wherein the compressed CSI replaces a precoding matrix indicator payload, a channel quality indicator payload, a rank indicator payload, and a W1 codebook payload in a CSI report to be transmitted by the UE.

Aspect 6: The method of any of Aspects 1-5, wherein the input of the model is based at least in part on a projection of a channel matrix, wherein the projection is onto a set of beams of a codebook.

Aspect 7: The method of any of Aspects 1-6, wherein the input of the neural network model is based at least in part on a singular value decomposition (SVD) associated with the channel information.

Aspect 8: The method of Aspect 7, wherein the input of the neural network model includes one or more singular values of the SVD associated with the channel information.

Aspect 9: The method of Aspect 7, wherein the input of the neural network model includes one or more singular vectors of the SVD associated with the channel information.

Aspect 10: The method of Aspect 9, wherein the one or more singular vectors of the SVD are right singular vectors.

Aspect 11: The method of Aspect 7, wherein the compressed CSI replaces at least a precoding matrix indicator payload and a W1 codebook payload in a CSI report to be transmitted by the UE.

Aspect 12: The method of any of Aspects 1-11, wherein the compressed CSI replaces at least a precoding matrix indicator payload in a CSI report to be transmitted by the UE.

Aspect 13: The method of any of Aspects 1-12, wherein the neural network model is an artificial neural network encoder.

Aspect 14: The method of any of Aspects 1-13, further comprising: receiving information indicating a maximum payload size, wherein generating the compressed CSI is based at least in part on the maximum payload size.

Aspect 15: The method of any of Aspects 1-14, further comprising: receiving a set of parameters for the model, wherein generating the compressed CSI is based at least in part on the set of parameters.

Aspect 16: The method of any of Aspects 1-15, wherein a compression scheme for the compressed CSI is based at least in part on a number of layers associated with the compressed CSI.

Aspect 17: The method of any of Aspects 1-16, wherein the input of the neural network model is based at least in part on a matrix containing one or more frequency-domain bases derived from the channel information.

Aspect 18: A method of wireless communication performed by a network node, comprising: receiving compressed channel state information (CSI) that is compressed in a frequency domain; decompressing the compressed CSI using a neural network model to obtain channel information; and configuring a communication based at least in part on the channel information.

Aspect 19: The method of Aspect 18, wherein the channel information is based at least in part on a channel matrix representing a channel in the frequency domain.

Aspect 20: The method of any of Aspects 18-19, wherein the compressed CSI is based at least in part on an average of the channel information across a set of resource blocks (RBs).

Aspect 21: The method of Aspect 20, further comprising: transmitting an indication of a granularity indicating a number of RBs included in the set of RBs.

Aspect 22: The method of Aspect 20, wherein the compressed CSI replaces a precoding matrix indicator payload, a channel quality indicator payload, a rank indicator payload, and a W1 codebook payload in a CSI report.

Aspect 23: The method of any of Aspects 18-22, wherein the compressed CSI is based at least in part on a projection of a channel matrix, wherein the projection is onto a set of beams of a codebook.

Aspect 24: The method of any of Aspects 18-23, wherein the compressed CSI is based at least in part on a singular value decomposition (SVD) associated with the channel information.

Aspect 25: The method of Aspect 24, wherein the compressed CSI replaces at least a precoding matrix indicator payload and a W1 codebook payload in a CSI report.

Aspect 26: The method of any of Aspects 18-25, wherein the compressed CSI replaces at least a precoding matrix indicator payload in a CSI report.

Aspect 27: The method of any of Aspects 18-26, wherein the neural network model is an artificial neural network decoder.

Aspect 28: The method of any of Aspects 18-27, further comprising: transmitting information indicating a maximum payload size, wherein the compressed CSI is based at least in part on the maximum payload size.

Aspect 29: The method of any of Aspects 18-28, further comprising: transmitting a set of parameters for a neural network encoder associated with generating the compressed CSI.

Aspect 30: An apparatus for wireless communication at a device, comprising a processor; memory coupled with the processor; and instructions stored in the memory and executable by the processor to cause the apparatus to perform the method of one or more of Aspects 1-29.

Aspect 31: A device for wireless communication, comprising a memory and one or more processors coupled to the memory, the one or more processors configured to perform the method of one or more of Aspects 1-29.

Aspect 32: An apparatus for wireless communication, comprising at least one means for performing the method of one or more of Aspects 1-29.

Aspect 33: A non-transitory computer-readable medium storing code for wireless communication, the code comprising instructions executable by a processor to perform the method of one or more of Aspects 1-29.

Aspect 34: A non-transitory computer-readable medium storing a set of instructions for wireless communication, the set of instructions comprising one or more instructions that, when executed by one or more processors of a device, cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
identify channel information based at least in part on a set of channel state information reference signals (CSI-RSs);
generate compressed channel state information (CSI) using a neural network model, wherein an input of the neural network model is based at least in part on the channel information, and wherein the compressed CSI is compressed in a frequency domain; and
transmit the compressed CSI.

2. The UE of claim 1, wherein the channel information is based at least in part on a channel matrix representing a channel in the frequency domain.

3. The UE of claim 1, wherein the input of the neural network model is based at least in part on an average of the channel information across a set of resource blocks (RBs).

4. The UE of claim 3, wherein the one or more processors are further configured to:
receive an indication of a granularity indicating a number of RBs included in the set of RBs.

5. The UE of claim 3, wherein the compressed CSI replaces a precoding matrix indicator payload, a channel quality indicator payload, a rank indicator payload, and a W1 codebook payload in a CSI report to be transmitted by the UE.

6. The UE of claim 1, wherein the input of the neural network model is based at least in part on a projection of a channel matrix, wherein the projection is onto a set of beams of a codebook.

7. The UE of claim 1, wherein the input of the neural network model is based at least in part on a singular value decomposition (SVD) associated with the channel information.

8. The UE of claim 7, wherein the input of the neural network model includes one or more singular values of the SVD associated with the channel information.

9. The UE of claim 7, wherein the input of the neural network model includes one or more singular vectors of the SVD associated with the channel information.

10. The UE of claim 9, wherein the one or more singular vectors of the SVD are right singular vectors.

11. The UE of claim 7, wherein the compressed CSI replaces at least a precoding matrix indicator payload and a W1 codebook payload in a CSI report to be transmitted by the UE.

12. The UE of claim 1, wherein the compressed CSI replaces at least a precoding matrix indicator payload in a CSI report to be transmitted by the UE.

13. The UE of claim 1, wherein the neural network model is an artificial neural network encoder.

14. The UE of claim 1, wherein the one or more processors are further configured to:
receive information indicating a maximum payload size, wherein generating the compressed CSI is based at least in part on the maximum payload size.

15. The UE of claim 1, wherein the one or more processors are further configured to:
receive a set of parameters for the neural network model, wherein generating the compressed CSI is based at least in part on the set of parameters.

16. The UE of claim 1, wherein a compression scheme for the compressed CSI is based at least in part on a number of layers associated with the compressed CSI.

17. The UE of claim 1, wherein the input of the neural network model is based at least in part on a matrix containing one or more frequency-domain bases derived from the channel information.

18. A network node for wireless communication, comprising:
a memory; and
one or more processors, coupled to the memory, configured to:
receive compressed channel state information (CSI) that is compressed in a frequency domain;
decompress the compressed CSI using a neural network model to obtain channel information; and
configure a communication based at least in part on the channel information.

19. The network node of claim 18, wherein the channel information is based at least in part on a channel matrix representing a channel in the frequency domain.

20. The network node of claim 18, wherein the compressed CSI is based at least in part on an average of the channel information across a set of resource blocks (RBs).

21. The network node of claim 20, wherein the one or more processors are further configured to:
transmit an indication of a granularity indicating a number of RBs included in the set of RBs.

22. The network node of claim 20, wherein the compressed CSI replaces a precoding matrix indicator payload, a channel quality indicator payload, a rank indicator payload, and a W1 codebook payload in a CSI report.

23. The network node of claim 18, wherein the compressed CSI is based at least in part on a projection of a channel matrix, wherein the projection is onto a set of beams of a codebook.

24. The network node of claim 18, wherein the compressed CSI is based at least in part on a singular value decomposition (SVD) associated with the channel information.

25. The network node of claim 18, wherein the compressed CSI replaces at least a precoding matrix indicator payload in a CSI report.

26. The network node of claim 18, wherein the neural network model is an artificial neural network decoder.

27. The network node of claim 18, wherein the one or more processors are further configured to:
transmit information indicating a maximum payload size, wherein the compressed CSI is based at least in part on the maximum payload size.

28. The network node of claim 18, wherein the one or more processors are further configured to:
transmit a set of parameters for a neural network encoder associated with generating the compressed CSI.

29. A method of wireless communication performed by a user equipment (UE), comprising:
identifying channel information based at least in part on a set of channel state information reference signals (CSI-RSs);
generating compressed channel state information (CSI) using a neural network model, wherein an input of the neural network model is based at least in part on the channel information, and wherein the compressed CSI is compressed in a frequency domain; and
transmitting the compressed CSI.

30. A method of wireless communication performed by a network node, comprising:
receiving compressed channel state information (CSI) that is compressed in a frequency domain;
decompressing the compressed CSI using a neural network model to obtain channel information; and
configuring a communication based at least in part on the channel information.
